(19) United States
(12) Patent Application Publication
(10) Pub. No.: US 2019/0026736 A1
(43) Pub. Date: Jan. 24, 2019

(54) ELECTRONIC SIGNATURE PROCESSING APPARATUS AND METHODS

(71) Applicant: Mastercard International Incorporated, Purchase, NY (US)

(72) Inventors: Nishant Maheshwari, Aligarh (IN); Randhir Kumar, Samastipur (IN); Manish Kumar, Gurgaon (IN)

(73) Assignee: Mastercard International Incorporated, Purchase, NY (US)

(21) Appl. No.: 16/009,654

(22) Filed: Jun. 15, 2018

(30) Foreign Application Priority Data
Jul. 18, 2017 (SG) 10201705868T

(51) Int. Cl. G06Q 20/38; G06Q 20/40

(52) U.S. Cl. CPC G06Q 20/3825; G06Q 20/409

(57) ABSTRACT

An apparatus for processing electronic signatures is provided. The apparatus comprises: a computer processor and a data storage device, the data storage device having a signatory interaction module; a transaction processing module and an electronic signature generation module comprising instructions operative by the processor to: provide a document to be signed to a device associated with a signatory party; receive, from the device associated with the signatory party, an indication of a payment card of the signatory party; generate a payment transaction authorization request, the payment transaction authorization request comprising an indication of the payment card of the signatory party; receive a payment transaction authorization response, the payment transaction authorization response comprising an indication of an account holder name associated with the payment card of the signatory party; and digitally sign the document by storing, in association with an indication of the document, an electronic signature indication comprising an indication of the account holder name associated with the payment card.

### CROSS REFERENCE TO RELATED APPLICATIONS

This application claims priority to Singapore Application Serial No. 10201705868T, filed Jul. 18, 2017, which is incorporated herein by reference in its entirety

### TECHNICAL FIELD AND BACKGROUND

The present disclosure relates to electronic signature processing.

Examples of scenarios in which electronic signatures may be used include the scenario in which one party signs a contract, for example terms of service for a website, software, etc., and the scenario in which two parties both sign a contract, for example a lease agreement between the two parties.

In existing electronic signature systems, a trusted service provider (TSP) typically stores a signature, for example in the form of an image, and when a party such as an individual wishes to electronically sign a document, that party logs on to a server provided by the TSP. Such electronic signature systems have a disadvantage that a customer must register and have an account with the TSP in order to use the services to provide electronic signatures.

### SUMMARY

In general terms, the present disclosure proposes an electronic signature apparatus and method that uses existing infrastructure provided by a payment network. In order to verify the identity of a signatory, the signatory provides details of a payment card and a transaction authorization request is generated for a transaction on the payment card. The authorization of this transaction is used as an electronic signature.

According to a first aspect of the present disclosure, an apparatus for processing electronic signatures is provided. The apparatus comprises: a computer processor and a data storage device, the data storage device having a signatory interaction module; a transaction processing module and an electronic signature generation module comprising instructions operative by the processor to: provide a document to be signed to a device associated with a signatory party; receive, from the device associated with the signatory party, an indication of a payment card of the signatory party; generate a payment transaction authorization request, the payment transaction authorization request comprising an indication of the payment card of the signatory party; receive a payment transaction authorization response, the payment transaction authorization response comprising an indication of an account holder name associated with the payment card of the signatory party; and digitally sign the document by storing, in association with an indication of the document, an electronic signature indication comprising an indication of the account holder name associated with the payment card.

In an embodiment the electronic signature generation module further comprises instructions operative by the processor to: receive an indication of a name of the signatory party; and compare the name of the signatory party with the indication of the account holder name associated with the payment card of the signatory party, wherein the electronic signature indication is stored if the name of the signatory party corresponds to the name of the account holder associated with the payment card.

In an embodiment, the data storage device further comprises a document processing module comprising instructions operative by the processor to: receive an indication of the document to be signed and an indication of the signatory party from a device associated with an agreement provider.

In an embodiment the indication of the signatory party further comprises a contact indication for the signatory party. The contact indication may comprise a telephone number or email address.

In an embodiment, the document processing module further comprises instructions operative by the processor to: generate a link allowing access to the document to be signed and send an indication of the link to the contact indication for the signatory party.

In an embodiment, the transaction processing module further comprises instructions operative by the processor to: generate the payment transaction authorization request as a payment transaction authorization request for a transaction having a transaction of small monetary value, for example less than 1 USD or equivalent.

In an embodiment, the transaction processing module further comprises instructions operative by the processor to: include an override indication in the payment transaction authorization request to trigger a second factor authentication of the payment transaction authorization request.

In an embodiment, the transaction processing module further comprises instructions operative by the processor to: reverse the payment transaction authorization request in response to receiving the payment transaction authorization response.

In an embodiment, the electronic signature generation module further comprises instructions operative by the processor to: generate a time stamp indicating a time and/or date that the payment transaction authorization response was received and wherein the electronic signature indication further comprises the time stamp.

According to a second aspect of the present disclosure an electronic signature method is provided. The method comprises: providing by an signatory interaction module of the electronic signature processing server, an electronic document to be signed to a device associated with a signatory party; receiving, the signatory interaction module of the electronic signature processing server an indication of a payment card of the signatory party from the device associated with the signatory party; generating, in a transaction processing module of the electronic signature processing server, a payment transaction authorization request, the payment transaction authorization request comprising an indication of the payment card of the signatory party; receiving, in the transaction processing module of the electronic signature processing server, a payment transaction authorization response, the payment transaction authorization response comprising an indication of an account holder name associated with the payment card of the signatory party; and digitally signing the document in an electronic signature generation module of the electronic signature processing server, by storing, in association with an indication of the document, an electronic signature indication in an electronic signature repository coupled to the electronic signature processing server, the electronic signature indication comprising an indication of the account holder name associated with the payment card.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram showing a system for processing electronic signatures according to an embodiment of the present invention;

FIG. 2 is a block diagram illustrating a technical architecture of an electronic signature processing server according to an embodiment of the present invention;

FIG. 3 is a flowchart showing a method of generating an electronic signature according to an embodiment of the present invention; and

FIG. 4 is a flowchart showing further initial steps of an electronic signature processing method according to an embodiment of the present invention.

### DETAILED DESCRIPTION

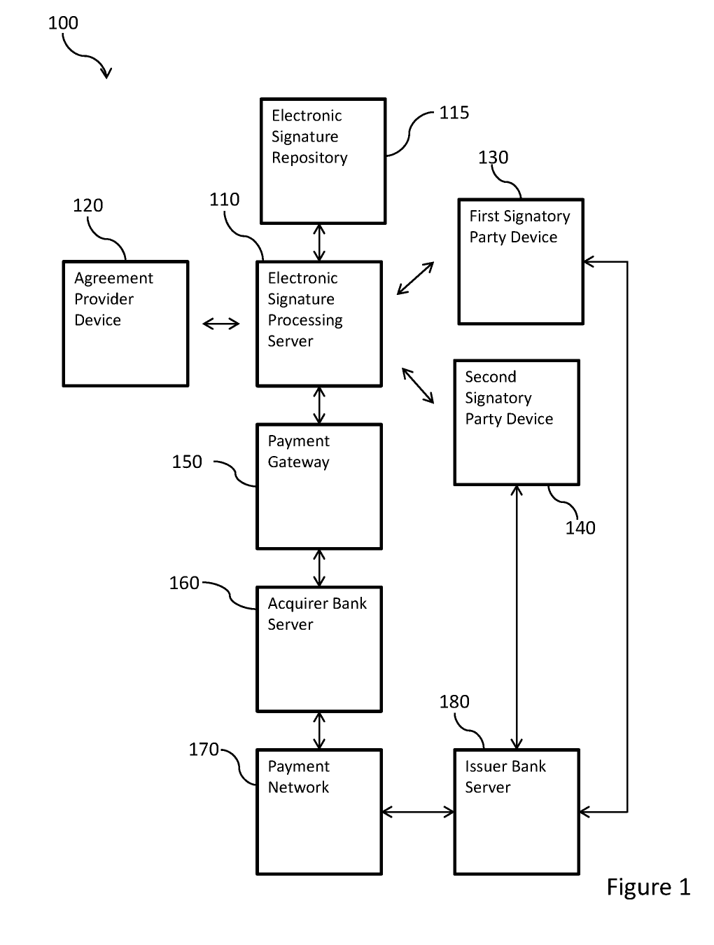

FIG. 1 is a block diagram showing a system for processing electronic signatures according to an embodiment of the present invention. The system 100 comprises an electronic signature processing server 110. An agreement provider device 120, a first signatory device 140 and a second signatory device 130 are communicatively coupled to the electronic signature processing server 110. It is envisaged that the agreement provider device 120, the first signatory device 140 and the second signatory device 130 are coupled to the electronic signature processing server 110 via a network such as the internet. The agreement provider device 120 is associated with a party that provides an agreement document for signature. In some embodiments, this party may also correspond to one of the signatory parties that will sign the agreement document. The first signatory party device 130 and the second signatory party device 140 are associated with the parties, such as individuals that will sign the agreement document by providing an electronic signature. While in the example shown in FIG. 1 there are two signatory parties, it is envisaged that the number of signatory parties may be different. In some embodiments, there may be a single signatory party, for example a scenario in which a customer signs a set of terms and conditions for a software application, further in some embodiments there may be more than two signatory parties.

The electronic signatory processing server 110 is coupled to an electronic signature repository 115. The electronic signature repository 115 stores copies of the agreement documents and electronic signature indications coupled to the agreement documents. The electronic signature indications comprise an indication of the name of the signatory party or signatory parties that have electronically signed the documents. The electronic signature indications may also comprise indications of timestamps. The electronic signature indications are generated using payment network infrastructure which is described below.

The electronic signature processing server 110 is coupled to a payment gateway 150. The payment gateway 150 provides a link to an acquirer bank server 160. It is noted that in some embodiments, the payment gateway 150 may be omitted and the electronic signature processing server 110 may communicate with the acquirer bank server 160. The acquirer bank server 160 is coupled to a payment network server 170 and the payment network server 180 is coupled to an issuer bank server 180.

In embodiments of the present invention, the first signatory party and the second signatory party use payment cards to verify their identity and thus provide electronic signatures which are stored in the electronic signature repository.

The payment network server 170 is a server associated with a payment network such as the Banknet payment network operated by MasterCard. As shown in FIG. 1 the payment network server 170 is coupled to an acquirer bank server 150 and an issuer bank server 180. The issuer bank server 180 is a server associated with a bank that has issued a payment card to the signatory parties. It is noted here that the first signatory party and the second signatory party may have payment cards issued by different issuer banks. Communication between the servers may take place via any type of network, for example, a virtual private network (VPN), the Internet, a local area and/or wide area network (LAN and/or WAN), and so on.

As shown in FIG. 1, there is a communication link between the issuer bank server 180 and the first signatory party device 130; and also a communication link between the issuer bank server 180 and the second signatory party device 140. These communication links may be used to perform second factor authentication of payment transactions made using the payment cards associated with the respective first and second signatory parties. This second factor authentication may be carried out by sending a text message to the device associated with the respective signatory party for entry into a web page provided by the electronic signature processing server.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e. without physical existence), which is registered with a digital wallet or cloud wallet.

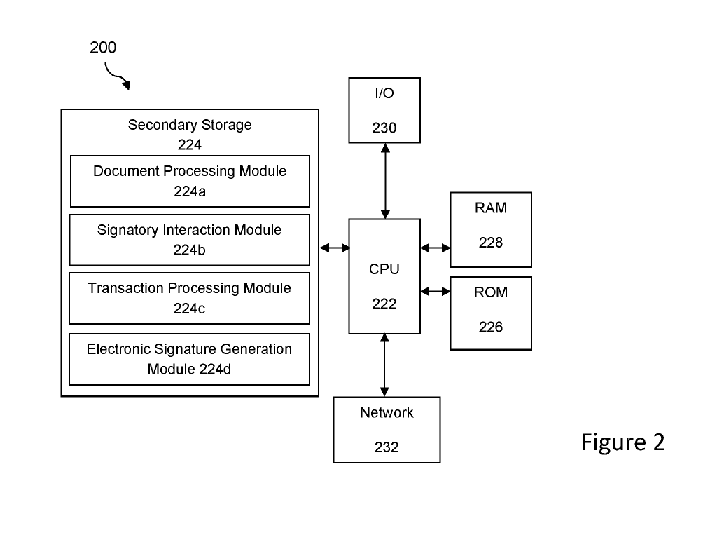

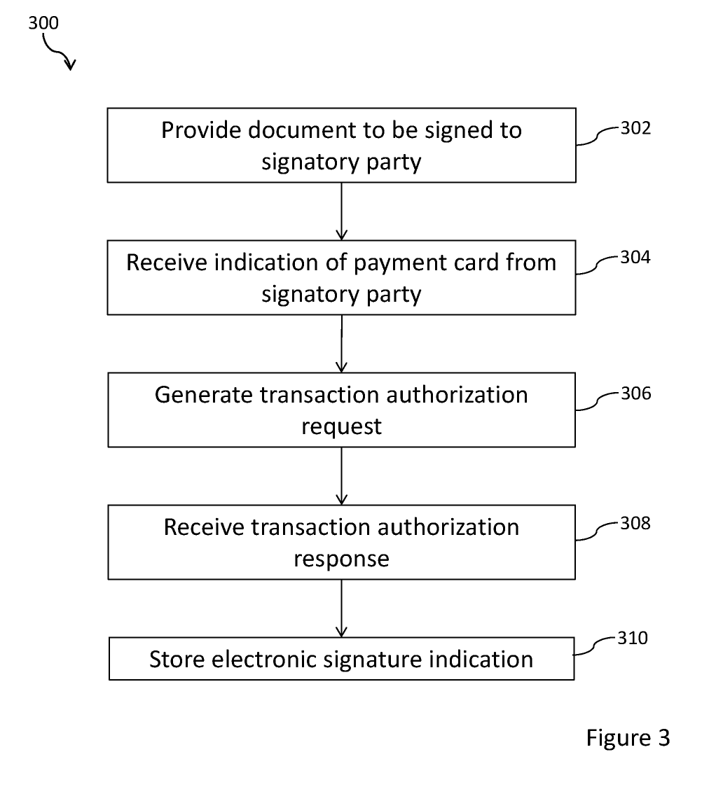

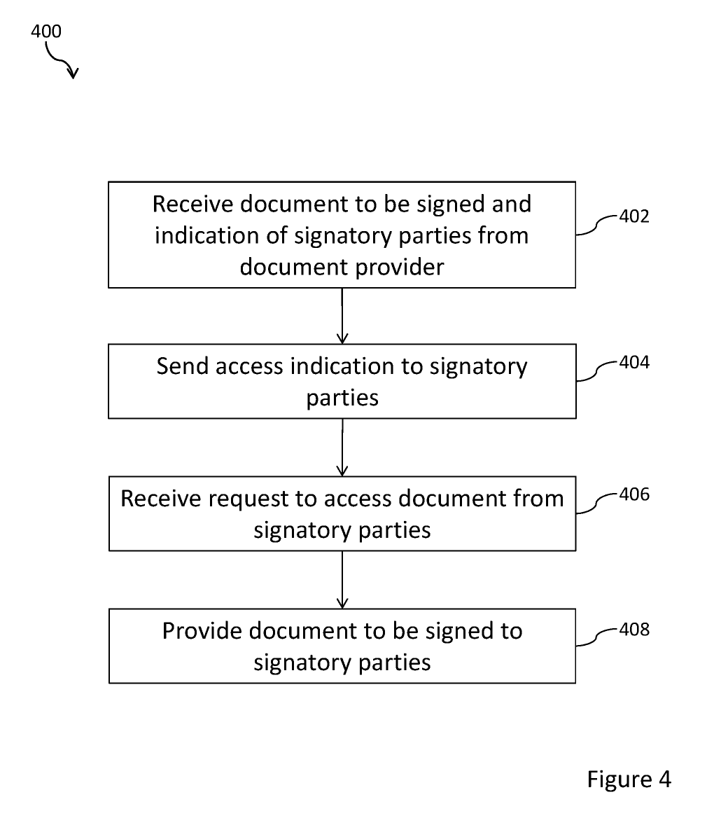

FIG. 2 is a block diagram showing a technical architecture 200 of the electronic signature processing server 110 for performing steps of exemplary methods 300 and 400, which are described below with reference to FIGS. 3 and 4. Typically, the methods 300 and 400 are implemented by a number of computers each having a data-processing unit. The block diagram as shown in FIG. 2 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a document processing module 224a, a signatory interaction module 224b, a transaction processing module 224c, and an electronic signature generation module 224d comprising non-transitory instructions operative by the processor 222 to perform various operations of the method of the present disclosure. As depicted in FIG. 2, the modules 224a-224d are distinct modules which perform respective functions implemented by the electronic signature processing server 110. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224d is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modern banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the method operations described herein. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Various operations of an exemplary method 300 will now be described with reference to FIG. 3 in respect of generating an electronic signature. It should be noted that enumeration of operations is for purposes of clarity and that the operations need not be performed in the order implied by the enumeration.

FIG. 3 is a flow chart showing a method of generating an electronic signature according to an embodiment of the present invention.

In step 302, the signatory interaction module 224b of the electronic signature processing server 110 provides a document to be signed to the first signatory party 130. In this exemplary method, only one signatory party is described, however, the method may also be implemented for more than one signatory party. The document to be signed may have been provided to the electronic signature processing server 110 by the agreement provider device 120. The process of providing the document to be signed to the electronic signature processing server 110 and receiving indications of the signatory party or signatory parties is described below with reference to FIG. 4.

The document to be signed may be for example a set of terms and conditions to use a website, software application or other on-line service. In such examples, the document to be signed may only be signed by the first signatory party 130. In other examples, the document to be signed may be a contact between two or more parties, in such case, both or all of the parties may electronically sign the document.

In order to certify their identity and electronically sign the document, the first signatory party 130 provides details of a payment card to the electronic signature processing server 110.

In step 304, the electronic signature processing server 110 receives an indication of a payment card from the first signatory party device 130. The electronic signature processing server 110 may provide an electronic form with spaces for the first signatory party to enter payment card details such as the payment card account number, expiry date, and cardholder name. Other data such as issue date of the payment card and card security code may also be entered in step 304. Data such as a postal code or ZIP code, and/or address may also be entered by the first signatory party into the first signatory party device 130 and transmitted to the electronic signature processing server 110. Additionally or alternatively, data such as IP address and/or device identifiers may also be transmitted to the electronic signature processing server 110.

In step 306, the transaction processing module 224c of the electronic signature processing server 110 generates a transaction authorization request for a payment transaction using the payment card details provided by the first signatory party. The transaction authorization request may be generated for a transaction of a small “token” amount. In some embodiments, the transaction authorization request may include a an override to ensure that a full transaction authorization process, for example, including second factor authentication is carried out during the processing of the transaction authorization request. Such an override may be included to ensure that transaction is not subjected to a minimal authentication due to its low value amount. Here the amount below which is considered to be a low value amount would be set by the issuer and transactions below such an amount would generally not be subjected to a full authentication process. The threshold below which a transaction is considered to be a low value amount may be for example 1 USD or equivalent.

The transaction authorization request is sent to the payment gateway 150 by the transaction processing module 224c of the electronic signature processing server 110. The transaction authorization request may be sent to the payment gateway 150 via an encrypted connection such as a secure socket layer (SSL) encrypted connection in a format such as extended mark-up language (XML). The payment gateway 150 converts the transaction authorization message to a message format such as the ISO-8583 message format.

The converted message is provided to the acquirer bank server 160 which acts as a payment processor and identifies a payment network associated with the payment card of the first signatory party. The message is then forwarded to the payment network server 170 corresponding to the identified payment network. The payment network server 170, then routes the transaction authorization request to the issuing bank server 180 corresponding to the banking organisation that issued the payment card.

The issuing bank server 180 authenticates the details of the payment card. The authentication process may include second factor authentication. This second factor authentication may comprise, for example, sending a text message to the first signatory party device 130 or other mobile device associated with the first signatory party. The first signatory party then enters an authentication code included in the text message into a web form provided by the electronic signature processing server 110. As mentioned above, the transaction authorization request may include an override to ensure that such a second factor authentication takes place during the authentication process. The authentication process may include, but not limited to, a biometric, location based, behavioural biometrics, and/or proximity based authentication.

If the authentication is successful, the issuer bank server 180 generates a transaction authorization response. The transaction authorization response includes an indication of the cardholder name associated with the payment card.

The transaction authorization response is sent to the electronic signature processing server 110 via the payment network 170, the acquirer bank server 160 and the payment gateway 150.

In some embodiments, the transaction may be reversed so that either no amount is debit from the signatory account or the amount debited is credited back into the signatory account.

In step 308, the transaction processing module 224c of the electronic signature processing server 110 receives the transaction authorization response.

In step 310, the electronic signature generation module 224d generates an electronic signature indication using the transaction authorization response and stores the electronic signature indication in the electronic signature repository. In some embodiments, the electronic signature generation module may compare a signatory name with a name corresponding to the cardholder of the payment card and only store the electronic signature if there is match between the signatory name and the name associated with the cardholder.

The electronic signature comprises an indication of document and an indication of the cardholder name associated with the payment card. In some embodiment, the electronic signature indication may also comprise a time stamp indicating the time and/or date that the transaction authorization response was received. In some embodiments the time stamp may indicate the time that the signatory party provided the payment card details.

Various operations of an exemplary method 400 will now be described with reference to FIG. 4 in respect of further steps of a method of generating an electronic signature. It should be noted that enumeration of operations is for purposes of clarity and that the operations need not be performed in the order implied by the enumeration. The method shown in FIG. 4 may precede the method shown in FIG. 3.

FIG. 4 is a flow chart showing further initial steps of an electronic signature processing method according to an embodiment of the present invention.

In step 402, the document processing module 224a of the electronic signature processing server 110 receives a document to be signed and an indication of the signatory parties from the agreement provider device 120. The document to be signed may be provided as an electronic document in an electronic document format such as extended mark-up language (XML); portable document format (PDF) or other electronic document format.

The indications of the signatory parties may comprise indications of email addresses or other unique identifiers such as mobile telephone numbers or login identities that allow the signatory parties to be uniquely identified and also for an electronic message such as an email message or text message to be sent to a signatory device associated with the signatory parties. The indications of the signatory parties may also include an indication of the name of the signatory parties.

In step 404, the signatory interaction module 224b of the electronic signature processing server 110 sends an access indication to each of the signatory parties. The access indication comprises a link or indication of a webpage that allows the signatory parties to access the document to be signed on the electronic signature processing server 110. Referring to FIG. 1, a first access indication is sent to the first signatory party device 130 and a second access indication is sent to the second signatory party device 140.

Following step 404, the signatory parties follow the link provided in the access indications.

In step 406, the signatory interaction module 224b of the electronic signature processing server 110 receives a request to access the documents from the signatory parties.

In step 408, in response to the access request the signatory interaction module 224b of the electronic signature processing server 110 provides the document to be signed to each of the signatory parties.

The method then continues as described above in relation to FIG. 3.

As described above, embodiments of the present invention provide an electronic signature generation method that uses the authentication provided by a payment network. Thus there is no new sign up required to use the electronic signature generation method since it relies on data already provided to issuer organisations during opening of payment card accounts.

Whilst the foregoing description has described exemplary embodiments, it will be understood by those skilled in the art that many variations of the embodiment can be made within the scope and spirit of the present invention.

1. An apparatus for processing electronic signatures, the apparatus comprising:
a computer processor and a data storage device, the data storage device having a signatory interaction module; a transaction processing module and an electronic signature generation module comprising instructions operative by the processor to:
transmit a document to be signed to a device associated with a signatory party;
receive, from the device associated with the signatory party, an indication of a payment card of the signatory party;
generate a payment transaction authorization request, the payment transaction authorization request comprising an indication of the payment card of the signatory party;
receive a payment transaction authorization response, the payment transaction authorization response comprising an indication of an account holder name associated with the payment card of the signatory party; and
digitally sign the document by storing, in association with an indication of the document, an electronic signature indication comprising an indication of the account holder name associated with the payment card.

2. An apparatus according to claim 1, wherein the electronic signature generation module further comprises instructions operative by the processor to:
receive an indication of a name of the signatory party; and
compare the name of the signatory party with the indication of the account holder name associated with the payment card of the signatory party, wherein the electronic signature indication is stored if the name of the signatory party corresponds to the name of the account holder associated with the payment card.

3. An apparatus according to claim 1, the data storage device further comprising a document processing module comprising instructions operative by the processor to:
receive an indication of the document to be signed and an indication of the signatory party from a device associated with an agreement provider.

4. An apparatus according to claim 3, wherein the indication of the signatory party further comprises a contact indication for the signatory party.

5. An apparatus according to claim 4, wherein the contact indication comprises a telephone number or email address.

6. An apparatus according to claim 4, wherein the document processing module further comprises instructions operative by the processor to: generate a link allowing access to the document to be signed and send an indication of the link to the contact indication for the signatory party.

7. An apparatus according to claim 1, wherein the transaction processing module further comprises instructions operative by the processor to: generate the payment transaction authorization request as a payment transaction authorization request for a transaction having a transaction amount of less than 1 USD or equivalent.

8. An apparatus according to claim 1, wherein the transaction processing module further comprises instructions operative by the processor to: include an override indication in the payment transaction authorization request to trigger a second factor authentication of the payment transaction authorization request.

9. An apparatus according to claim 1, wherein the transaction processing module further comprises instructions operative by the processor to: reverse the payment transaction authorization request in response to receiving the payment transaction authorization response.

10. An apparatus according to claim 1, the electronic signature generation module further comprising instructions operative by the processor to: generate a time stamp indicating a time and/or date that the payment transaction authorization response was received and wherein the electronic signature indication further comprises the time stamp.

11. An electronic signature processing method in an electronic signature processing server, the method comprising:
transmitting, by an signatory interaction module of the electronic signature processing server, an electronic document to be signed to a device associated with a signatory party;
receiving, the signatory interaction module of the electronic signature processing server an indication of a payment card of the signatory party from the device associated with the signatory party;
generating, in a transaction processing module of the electronic signature processing server, a payment transaction authorization request, the payment transaction authorization request comprising an indication of the payment card of the signatory party;
receiving, in the transaction processing module of the electronic signature processing server, a payment transaction authorization response, the payment transaction authorization response comprising an indication of an account holder name associated with the payment card of the signatory party; and
digitally signing the document, in an electronic signature generation module of the electronic signature processing server, by storing, in association with an indication of the document, an electronic signature indication in an electronic signature repository coupled to the electronic signature processing server, the electronic signature indication comprising an indication of the account holder name associated with the payment card.

12. An electronic signature processing method according to claim 11, further comprising
receiving, an indication of a name of the signatory party; and
comparing the name of the signatory party with the indication of the account holder name associated with the payment card of the signatory party, wherein the electronic signature indication is stored if the name of the signatory party corresponds to the name of the account holder associated with the payment card.

13. An electronic signature processing method according to claim 11, further comprising:
receiving, in a document processing module of the electronic signature processing server, an indication of the document to be signed and an indication of the signatory party from a device associated with an agreement provider.

14. An electronic signature processing method according to claim 13, wherein the indication of the signatory party further comprises a contact indication for the signatory party.

15. An electronic signature processing method according to claim 14, further comprising: generating a link allowing access to the document to be signed and sending an indication of the link to the contact indication for the signatory party.

16. An electronic signature processing method according to claim 11, wherein the payment transaction authorization request is a payment transaction authorization request for a transaction having a transaction amount of less than 1 USD or equivalent.

17. An electronic signature processing method according to claim 11, wherein the payment transaction authorization request comprises an override indication to trigger a second factor authentication of the payment transaction authorization request.

18. An electronic signature processing method according to claim 11, further comprising reversing the payment transaction authorization request in response to receiving the payment transaction authorization response.

19. An electronic signature processing method according to claim 11, generating a time stamp indicating a time and/or date that the payment transaction authorization response was received and wherein the electronic signature indication further comprises the time stamp.

20. A non-transitory computer readable medium carrying computer executable instructions which when executed on at least one processor cause the at least one processor to carry out a method according to claim 11.
